(19) United States
(12) Patent Application Publication
(10) Pub. No.: US 2009/0030175 A1
(43) Pub. Date: Jan. 29, 2009

(54) Process for producing fluoropolymer by ring-opening polymerization of fluorinated epoxy compound

(75) Inventors: Hiromasa Yamamoto, Tokyo (JP); Kyoko Nozaki, Tokyo (JP); Koji Nakano, Tokyo (JP)

Correspondence Address: FOLEY AND LARDNER LLP;SUITE 500, 3000 K STREET NW, WASHINGTON, DC, 20007, US

(73) Assignee: ASAHI GLASS COMPANY, LIMITED

(21) Appl. No.: 12/230,999

(22) Filed: Sep. 9, 2008

Related U.S. Application Data
(63) Continuation of application No. PCT/JP07/54723, filed on Mar. 9, 2007.

(30) Foreign Application Priority Data
Mar. 10, 2006 (JP) 2006-066444

(51) Int. Cl. C08G 65/26

(52) U.S. Cl. 528/402

(57) ABSTRACT

There is provided a polymer having electrical/optical functions attributed to the stability of a C—F bond in addition to chemical stability by efficiently polymerizing a fluorinated epoxy compound. A process for producing a fluoropolymer having two or more units of a repeating unit represented by the following formula (2), which comprises ring-opening polymerization of a fluorinated epoxy compound represented by the following formula (1) in the presence of a trialkylaluminum and a salt having an organic cation as a counter cation:

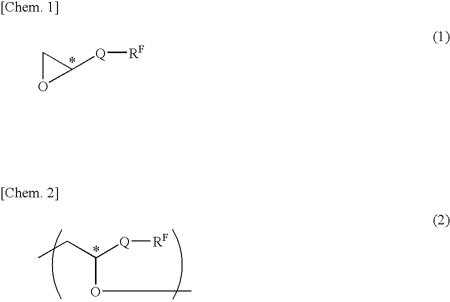

wherein Q represents a single bond or a bivalent linking group containing no fluorine atom; R^{F} represents a monovalent organic group containing a fluorine atom; and * indicates that the carbon atom marked with * is an asymmetric carbon atom.

### TECHNICAL FIELD

The present invention relates to a process for producing a fluoropolymer by ring-opening polymerization of a fluorinated epoxy compound.

### BACKGROUND ART

Fluoropolymers have properties excellent in heat resistance, chemical resistance, weather resistance, gas barrier properties, and the like and have been employed in various fields including semiconductor industries, automobile industries, and the like. As a ring-opening polymerization reaction of a fluorinated epoxy compound, there has been reported a ring-opening polymerization reaction of an epoxide having a perfluoroalkyl group. For example, a homopolymerization reaction of 3,3,3-trifluoro-1,2-epoxypropane and a copolymerization reaction with 1,2-epoxypropane have been known (see Non-Patent Documents 1 to 3 below).

Non-Patent Document 1: Hagiwara, T.; Terasaki, Y.; Hamana, H.; Narita, T.; Umezawa, J.; Furuhashi, K. Makromol. Chem. Rapid Commun. 1992, 13, 363.

Non-Patent Document 2: Umezawa, J.; Hagiwara, T.; Hamana, H.; Narita, T.; Furuhashi, K.; Nohira, H. Polym. J. 1994, 26, 715.

Non-Patent Document 3: Umezawa, J.; Hagiwara, T.; Hamana, H.; Narita, T.; Furuhashi, K.; Nohira, H. Macromolecules 1995, 28, 833.

### DISCLOSURE OF THE INVENTION

### Problems to be Solved by the Invention

In the conventional process of ring-opening polymerization of a fluorinated epoxy compound using a zinc complex as a catalyst, polymerization activity of the epoxide is low, and hence it necessitates a polymerization reaction at a high temperature condition (80° C. or higher) for a long period of time (about 24 hours).

Moreover, it has been known to carry out ring-opening polymerization using a non-fluorinated epoxide in the presence of triisobutylaluminum and sodium isopropoxide, but there has been completely no knowledge as to whether or not the process is applicable to a reaction with a fluorinated epoxide.

### Means for Solving the Problems

As a result of the studies on the polymerization reaction of an epoxide substituted with a fluorinated group, the present inventors found that when the polymerization reaction is carried out in a reaction system in which a trialkylaluminum compound and a salt having an organic cation as a counter cation are present, the polymerization activity of the epoxide is enhanced and an objective polymer is obtained.

Namely, the invention provides the following inventions.

1. A process for producing a fluoropolymer having two or more units of a repeating unit represented by the following formula (2), which comprises ring-opening polymerization of a fluorinated epoxy compound represented by the following formula (1) in the presence of a trialkylaluminum and a salt having an organic cation as a counter cation:

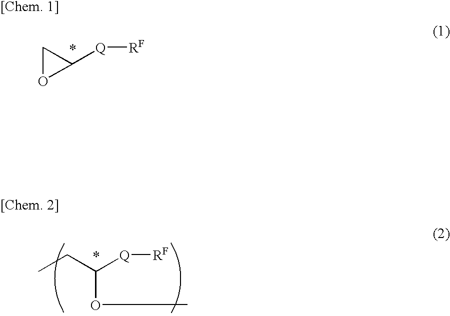

wherein Q represents a single bond or a bivalent linking group containing no fluorine atom; R^{F} represents a monovalent organic group containing a fluorine atom; and * indicates that the carbon atom marked with * is an asymmetric carbon atom.

2. The process for producing the fluoropolymer according to the above 1, wherein the ring-opening polymerization is a reaction of ring-opening homopolymerization of a fluorinated epoxy compound represented by the formula (1).

3. The process for producing the fluoropolymer according to the above 1 or 2, wherein the fluorinated epoxy compound represented by the formula (1) consists of a compound in which the absolute configuration of the asymmetric carbon atom marked with * is either exclusively S or exclusively R and the absolute configuration of the asymmetric carbon atom marked with * in the repeating unit represented by the following formula (2) is substantially the same as the absolute configuration of the asymmetric carbon atom in the fluorinated epoxy compound represented by the formula (1).

4. The process for producing the fluoropolymer according to any one of the above 1 to 3, wherein the trialkylaluminum is triisobutylaluminum and the salt having an organic cation as a counter cation is a cation represented by the following formula (3-1) or the following formula (3-2):

### [Chem. 3]

[Ph₃P═N═PPh₃]⁺ (3-1)

### [Chem. 4]

[Ph₃PMe]⁺ (3-2)

wherein Ph represents a phenyl group.

### ADVANTAGE OF THE INVENTION

According to the production process of the invention, a fluoropolymer having a high polymerization degree is obtained under mild reaction conditions. Since the polymerization reaction of the invention is a reaction capable of controlling regioregularity and capable of retaining the absolute configuration of an asymmetric carbon atom, a polymer having high regioregularity and stereoregularity can be obtained. For example, in the production process of the invention, in the case where a fluorinated polyether that is a homopolymer is produced as a fluoropolymer using, as a fluorinated epoxy compound represented by the formula (1), an optical isomer in which the carbon atom marked with * is R or S, the resulting fluorinated polyether is an isotactic polymer. The polymer has a three-dimensional structure and exhibits a large optical rotation.

Moreover, the fluoropolymer produced by the process of the invention has high heat resistance and light resistance attributed to the stability of a C—F bond. Namely, the polymer has both of chemical stability and electrical/optical functions attributed to a fluorine atom, so that it can be a specific functional optical material that cannot be realized by the other polymer material.

### BEST MODE FOR CARRYING OUT THE INVENTION

The invention relates to a process for producing a fluoropolymer having two or more units of a repeating unit represented by the following formula (2), which comprises ring-opening polymerization of a fluorinated epoxy compound represented by the following formula (1) (hereinafter sometimes referred to as compound represented by the formula (1)) in the presence of a trialkylaluminum and a salt having an organic cation as a counter cation.

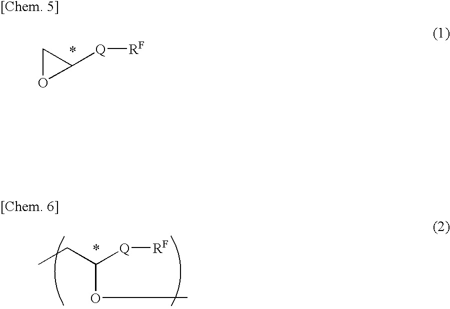

Q in the formula (1) represents a single bond or a bivalent linking group containing no fluorine atom and is preferably a bivalent linking group containing no fluorine atom. The bivalent linking group containing no fluorine atom is preferably an alkylene group or an alkylene group containing an etheric oxygen atom. The alkylene group is preferably a linear alkylene group having 1 or more carbon atoms, such as a methylene group (—CH₂—), a dimethylene group (—CH₂CH₂—), or a trimethylene group (—CH₂CH₂CH₂—), particularly preferably a linear alkylene group having 1 to 5 carbon atoms, especially preferably a linear alkylene group having 1 to 4 carbon atoms. The alkylene group containing an etheric oxygen atom is preferably a group containing an etheric oxygen atom inserted between the carbon-carbon atoms of the above alkylene group or a group containing an etheric oxygen atom inserted at the end of the above alkylene group, more preferably a group containing an etheric oxygen atom inserted at the end of the linear alkylene group having 1 to 4 carbon atoms or a group containing an etheric oxygen atom inserted at one or two sites between the carbon-carbon atom of a linear alkylene group having 2 to 4 carbon atoms (e.g., —CH₂O—, —CH₂OCH₂—, —CH₂OCH₂CH₂—, etc.). Furthermore, in the bivalent linking group containing no fluorine atom, the total number of the carbon atom and the oxygen atom is preferably 1 to 5 atoms.

R^{F} in the formula (1) represents a monovalent organic group containing a fluorine atom. The structure of R^{F} may be any of a linear structure, a branched structure, a ring structure, or a partially ring-containing structure. Moreover, in the case of a ring structure, R^{F} may be an aromatic group. R^{F} is preferably a fluorinated alkyl group (provided that a fluorine atom is bonded to the carbon atom bonded to Q), a fluorinated aryl group, or a fluorinated alkyl group containing an etheric oxygen atom (provided that a fluorine atom is bonded to the carbon atom bonded to Q) and preferred is a perfluoroalkyl group, a perfluoroaryl group, or a perfluoroalkyl group containing an etheric oxygen atom. The “perfluoro” means that all hydrogen atoms bonded to a carbon atom are replaced by fluorine atoms. R^{F} preferably has 1 to 8 carbon atoms. Specific examples of R^{F} include CF₃—, C₂F₅—, C₃F₇—, C₄F₉—, C₅F₁₁—, C₆F₁₃—, C₇F₁₅—, C₈F₁₇—, and C₆F₅— (perfluorophenyl group).

In the formula (1), * indicates that the carbon atom marked with * is an asymmetric carbon atom. In the present specification, the absolute configuration of the carbon atom is expressed by R or S. With regard to the compound represented by the formula (1) in the invention, the absolute configuration of the carbon atom marked with * may be any of exclusively R, exclusively S, or a mixture of R and S, but is preferably either exclusively R or exclusively S. In the expression of the chemical formulae in the description, in the case where stereochemistry of an asymmetric carbon is not defined, the case means a mixture of optical isomers wherein the configuration of the asymmetric carbon atom is R and S. An asymmetric carbon atom may be also present in Q and R^{F} but the configuration of the asymmetric carbon atom is also not limited.

The racemic substance of the compound represented by the formula (1) is a known compound and is available by a known production process or as a commercial product. Also, an optically active substance of the compound represented by the formula (1) is easily available by applying a general procedure, which is employed at optical resolution of an epoxide, to the racemic substance of the compound represented by the formula (1).

In the invention, a polymerization reaction of the compound represented by the formula (1) is carried out. In the polymerization reaction, one or more of the compound represented by the formula (1) may be polymerized or the compound represented by the formula (1) may be copolymerized with one or more of the other monomer(s) (hereinafter referred to as comonomer(s)), but the former polymerization reaction is preferable. In particular, the polymerization reaction wherein one species of the compounds represented by the formula (1) is polymerized, i.e., homopolymerization is preferable.

A feature of the present invention resides in carrying out the polymerization reaction in the presence of a trialkylaluminum and a salt having an organic cation as a counter cation. The trialkylaluminum is preferably triisobutylaluminum. The organic cation in the salt having an organic cation as a counter cation is preferably an ammonium ion or a phosphonium ion. Particularly, bis(triarylphosphoranylidene)ammonium ion, bis(trialkylphosphoranylidene)ammonium ion, or triarylalkylphosphoniumu ion is further preferable and a cation represented by the following formula (3-1) or a cation represented by the following formula (3-2) is particularly preferable. In the following formulae, Ph represents a phenyl group and Me represents a methyl group.

### [Chem. 7]

[Ph₃P═N═PPh₃]⁺ (3-1)

### [Chem. 8]

[Ph₃PMe]⁺ (3-2)

The above-described cation is preferably added into the reaction system in the form of a salt with a halogen anion and is preferably added into the reaction system in the form of a chloride salt or a bromide salt.

In the case where the organic cation is a non-coordinating cation such as the cation represented by the above formula (3-1) or the cation represented by the above formula (3-2), the polymerization terminal can be converted into an ate complex of aluminum, so that there is an advantage that polymerizing ability is improved. The polymerization reaction did not proceed when the salt with an organic cation was replaced with sodium isopropoxide which is a salt with an inorganic cation and is used for polymerization of non-fluorinated epoxy compounds.

The amount of the trialkylaluminum is preferably from 5 to 20 molar equivalent to the salt having an organic cation as a counter cation. The amount of the salt having an organic cation as a counter cation is preferably from 0.01 to 10% by mol based on the compound represented by the formula (1).

The ring-opening polymerization is preferably carried out in a homogeneous solution. The solvent is preferably a fluorinated solvent, can be appropriately selected depending on the solubility of the polymer to be formed, and is particularly preferably a perfluorinated solvent such as hexafluorobenzene. The temperature of the polymerization reaction is from 0 to 20° C. When the polymerization temperature is elevated, there is a tendency that it becomes hard to attain uniform stereoregularity of the polymer. The polymerization time is usually preferably from 1 to 5 hours. The polymerization pressure may be any of reduced pressure, elevated pressure, or atmospheric pressure and usually is preferably atmospheric pressure. Moreover, the inside of the system of the polymerization reaction is preferably replaced by an argon gas, a nitrogen gas, or the like. The polymer after completion of the reaction is preferably subjected to a suitable purification treatment as needed.

The molecular weight of the polymer produced by the process of the invention is preferably from 2,000 to 200,000, particularly preferably from 5,000 to 100,000.

According to the production process of the invention, it is possible to proceed with the polymerization reaction while maintaining the absolute configuration of the asymmetric carbon atom in the compound represented by the formula (1). For example, according to the production process of the invention, when the absolute configuration of the asymmetric carbon atom marked with * in the compound represented by the formula (1) is either exclusively S or exclusively R, the absolute configuration of the repeating unit represented by the formula (2) becomes substantially the same as the absolute configuration of the asymmetric carbon atom in the compound represented by the formula (1). The “substantially the same” means that the absolute configurations as determined by usual analytical means such as NMR are the same. Therefore, in the case where a chiral compound (1), wherein the absolute configuration of the asymmetric carbon atom marked with * is either exclusively S or exclusively R, is used as the compound represented by the formula (1), there can be produced a fluoropolymer wherein the absolute configuration of the asymmetric carbon atom marked with * in the repeating unit represented by the formula (2) is substantially the same as the absolute configuration of the asymmetric carbon atom in the fluorinated epoxy compound represented by the formula (1). Since the polymer obtained by the process is a stereoregular isotactic polymer, the product is an isotactic fluorinated polyether. The formation of the fluorinated polymer having a regulated configuration can be confirmed by analytical procedures such as NMR and optical rotation. Moreover, when another asymmetric carbon atom is present in addition to the asymmetric carbon atom marked with * in the formula (1), the absolute configuration of the former asymmetric carbon atom is not limited after and before the polymerization reaction.

The isotactic fluorinated polyether has a three-dimensional structure and exhibits a large optical rotation. Moreover, the fluoropolymer produced by the process of the invention has high heat resistance and light resistance attributed to the stability of a C—F bond. The fluoropolymer also has electrical/optical functions attributed to a fluorine atom in addition to such chemical stability, so that it can be a specific functional optical material that cannot be realized by the other polymer material. For example, the isotactic fluorinated polyether is useful as oil, rubber, and the like.

### EXAMPLES

The present invention will be illustrated in greater detail with reference to the following Examples, but the invention should not be construed as being limited thereto.

The perfluoroalkyl group has a linear structure and the measured values of molecular weight are values in terms of polymethyl methaceylate. The numbers in parentheses attached after the compound names in Examples correspond to the numbers attached to chemical formulae described in individual Examples. Moreover, the chemical shifts of NMR in Examples are measured values when the chemical shift of the peak appearing at the lowest magnetic field side among the peaks of perfluorobenzene is regarded as a reference value (141.99 ppm).

### Example 1

Under an argon gas atmosphere, bis(triphenylphosphoranylidene)ammonium chloride (2) (14.4 mg, 0.025 mmol) and hexafluorobenzene (2.0 mL) were placed in a 20 mL volume Schlenk tube reactor, an epoxide (1) (Q=—CH₂—, R^{F}═—C₄F₉ in the formula (1), 0.50 mL, 2.8 mmol) was added, and then a 1.0M toluene solution of triisobutylaluminum (0.25 mL, 0.25 mmol) was added, followed by stirring under ice cooling for 2 hours.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225 (manufactured by Asahi Glass Co., Ltd.; a mixture of CF₃CF₂CHCl₂ and CClF₂CF₂CHClF). The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [226 mg, yield 29%, Mₙ=16,600 (g/mol), M_{w}/Mₙ=1.8].

When ¹³C-NMR (125 MHz, solvent: C₆F₆) of the polymer was measured, the peaks derived from methylene of the polymer main chain were observed at 74.6 ppm (mm triplet), 74.3 ppm (mr triplet or rm triplet), 73.8 ppm (mr triplet or rm triplet), 73.6 ppm (rr triplet).

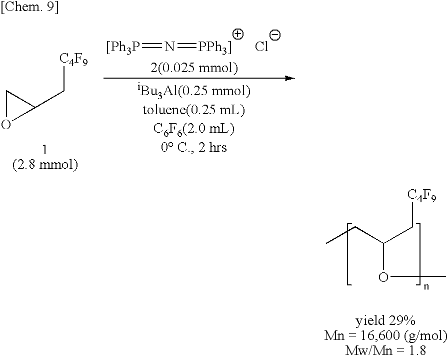

### Example 2

Under an argon gas atmosphere, bis(triphenylphosphoranylidene)ammonium chloride (2) (172 mg, 0.30 mmol) and hexafluorobenzene (24 mL) were placed in a 80 mL volume Schlenk tube reactor, an optically almost pure epoxide (1) [6.0 mL, 33.6 mmol, >99% ee, [α]_{D}²⁴=0.40° (c=4.7 g/100 mL, C₆F₆), absolute configuration=R] was added, and then a 1.0M toluene solution of triisobutylaluminum (3.0 mL, 3.0 mmol) was added, followed by stirring at room temperature for 3 hours.

A mixed solution of methanol/water/conc. hydrochloric acid (20 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (60 mL) was added to the residue to dissolve a polymer. After insoluble matter was filtrated off, the filtrate was concentrated and dried under vacuum to obtain a polymer [4.07 g, yield 44%, bimodal peaks: Mₙ=6,000 (g/mol), M_{w}/Mₙ=2.0 (ratio of the peak based on the total area of the bimodal peaks=66%); Mₙ=14,000 (g/mol), M_{w}/Mₙ=1.2 (ratio of the peak based on the total area of the bimodal peaks=34%), [α]_{D}²⁴=19° (c=2.7 g/100 mL, C₆F₆)].

When ¹³C-NMR (125 MHz, solvent: C₆F₆) of the polymer was measured, the peak derived from methylene of the polymer main chain was observed only at 74.6 ppm (mm triplet) and peaks of mr triplet, rm triplet, and rr triplet were not observed.

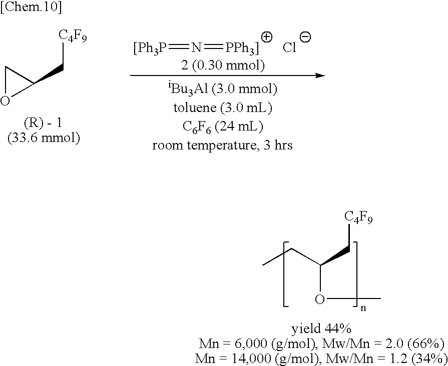

### Example 3

Under an argon gas atmosphere, methyltriphenylphosphonium chloride (3a) (7.8 mg, 0.025 mmol) and hexafluorobenzene (2.0 mL) were placed in a 20 mL volume Schlenk tube reactor, an epoxide (1) (0.50 mL, 2.8 mmol) was added, and then a 1.0M toluene solution of triisobutylaluminum (0.25 mL, 0.25 mmol) was added, followed by stirring under ice cooling for 2 hours.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [253 mg, yield 33%, Mₙ=11,000 (g/mol), M_{w}/Mₙ=1.9].

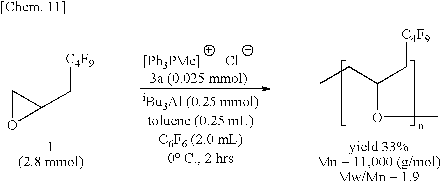

### Example 4

Under an argon gas atmosphere, methyltriphenylphosphonium bromide (3b) (8.9 mg, 0.025 mmol) and hexafluorobenzene (2.0 mL) were placed in a 20 mL volume Schlenk tube reactor, an epoxide (1) (0.50 mL, 2.8 mmol) was added, and then a 1.0M toluene solution of triisobutylaluminum (0.25 mL, 0.25 mmol) was added, followed by stirring under ice cooling for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [731 mg, yield 95%, Mₙ=14,300 (g/mol), M_{w}/Mₙ=2.1].

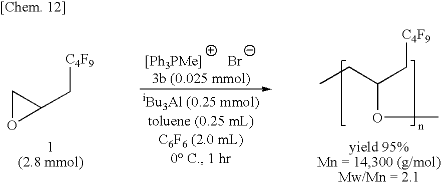

### Example 5

Under an argon gas atmosphere, methyltriphenylphosphonium bromide (3b) (8.9 mg, 0.025 mmol) and hexafluorobenzene (2.0 mL) were placed in a 20 mL volume Schlenk tube reactor, an epoxide (5) (Q=—CH₂OCH₂CH₂—, R^{F}=—C₆F₁₃ in the formula (1), 0.75 mL, 2.8 mmol) was added, and then a 1.0M toluene solution of triisobutylaluminum (0.25 mL, 0.25 mmol) was added, followed by stirring under ice cooling for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [1.13 g, yield 96%, Mₙ=28,100 (g/mol), M_{w}/Mₙ=1.9].

When ¹³C-NMR (125 MHz, solvent: C₆F₆) of the polymer was measured, the peaks derived from methylene of the main chain and methylene adjacent to the oxygen atom of the side chain were observed at around 72 to 74 ppm.

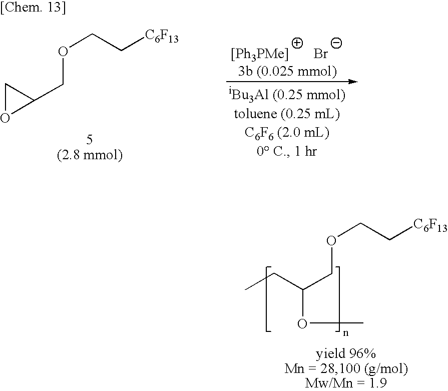

### Example 6

Under an argon gas atmosphere, methyltriphenylphosphonium bromide (3b) (8.9 mg, 0.025 mmol) and hexafluorobenzene (2.0 mL) were placed in a 20 mL volume Schlenk tube reactor, an optically almost pure epoxide (5) (0.75 mL, 2.8 mmol) was added, and then a 1.0M toluene solution of triisobutylaluminum (0.25 mL, 0.25 mmol) was added, followed by stirring under ice cooling for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [1.17 g, yield 99%, Mₙ=31,000 (g/mol), M_{w}/Mₙ=1.8].

When ¹³C-NMR (125 MHz, solvent: C₆F₆) of the polymer was measured, the peaks derived from methylene of the polymer main chain as mm triplet and methylene adjacent to the oxygen atom of the side chain as mm triplet were observed but the peaks derived from methylene contained in the polymer main chain and methylene adjacent to the oxygen atom as mr triplet, rm triplet, and rr triplet were not observed.

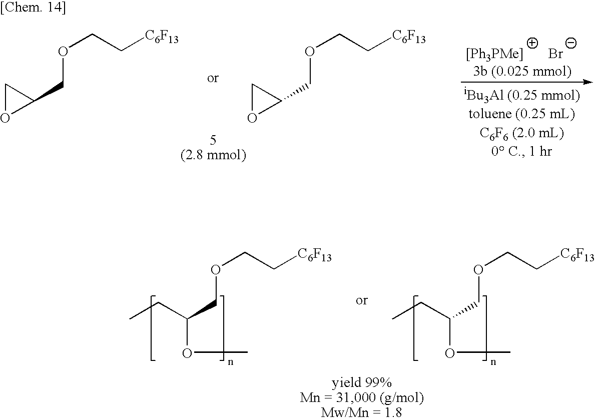

### Example 7

Under an argon gas atmosphere, methyltriphenylphosphonium bromide (3b) (8.9 mg, 0.025 mmol) and hexafluorobenzene (2.0 mL) were placed in a 20 mL volume Schlenk tube reactor, an epoxide (6) (Q=a single bond, R^{F}=—CF₃ in the formula (1), 0.25 mL, 2.8 mmol) was added, and then a 1.0M toluene solution of triisobutylaluminum (0.25 mL, 0.25 mmol) was added, followed by stirring at room temperature for 40 hours.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [162 mg, yield 52%, Mₙ=2,900 (g/mol), M_{w}/Mₙ=1.2].

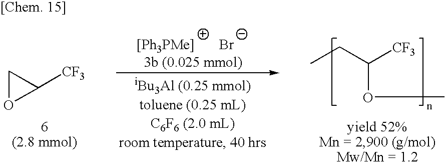

### Example 8

Under an argon gas atmosphere, bis(triphenylphosphoranylidene)ammonium chloride (2) (14.4 mg, 0.025 mmol) and hexafluorobenzene (2.0 mL) were placed in a 20 mL volume Schlenk tube reactor, an epoxide (6) (0.25 mL, 2.8 mmol) was added, and then a 11.0M toluene solution of triisobutylaluminum (0.25 mL, 0.25 mmol) was added, followed by stirring at room temperature for 40 hours. A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [179 mg, yield 57%, Mₙ=2,300 (g/mol), M_{w}/Mₙ=1.3].

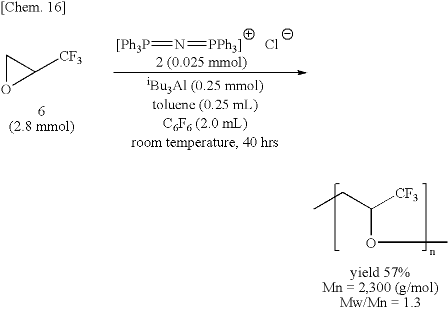

### Example 9

Under an argon gas atmosphere, methyltriphenylphosphonium chloride (3a) (7.8 mg, 0.025 mmol) and hexafluorobenzene (2.0 mL) were placed in a 20 mL volume Schlenk tube reactor, an epoxide (6) (0.25 mL, 2.8 mmol) was added, and then a 1.0M toluene solution of triisobutylaluminum (0.25 mL, 0.25 mmol) was added, followed by stirring at room temperature for 40 hours.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (15 mL) was added to the residue to dissolve a polymer. After insoluble matter was filtrated off, the filtrate was concentrated and dried under vacuum to obtain a polymer [140 mg, yield 45%, Mₙ=2,200 (g/mol), M_{w}/Mₙ=1.2].

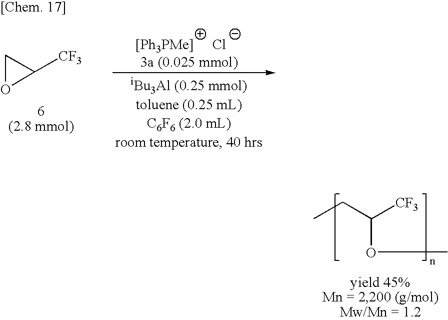

### Example 10

Under an argon gas atmosphere, methyltriphenylphosphonium bromide (3b) (8.9 mg, 0.025 mmol) and toluene (2.0 mL) were placed in a 20 mL volume Schlenk tube reactor, an epoxide (7) (Q=—CH₂—, R^{F}=—C₆F₅ in the formula (1), 0.41 mL, 2.80 mmol) was added, and then a 1.0M toluene solution of triisobutylaluminum (0.25 mL, 0.25 mmol) was added, followed by stirring at 0° C. for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using methylene chloride. The resulting mixed solution was concentrated and dried under vacuum and methylene chloride (90 mL) was added to the residue to dissolve a polymer. After insoluble matter was filtrated off, the filtrate was concentrated and dried under vacuum to obtain a polymer. On this occasion, in order to remove the residue of the initiator and oligomers, a re-precipitation treatment was performed using methylene chloride and hexane to thereby isolate the polymer [610 mg, yield 97%, Mₙ=20,000 (g/mol), M_{w}/Mₙ=1.2].

When ¹³C-NMR (125 MHz, solvent: CDCL₃) of the polymer was measured, plural peaks derived from methylene in the main chain of the polymer were observed from 71.2 to 72.4 ppm.

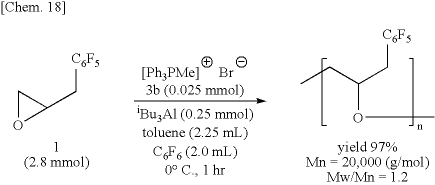

### Example 11

Under an argon gas atmosphere, methyltriphenylphosphonium bromide (3b) (8.9 mg, 0.025 mmol) and toluene (2.0 mL) were placed in a 20 mL volume Schlenk tube reactor, an optically almost pure epoxide (7) [0.41 mL, 2.80 mmol, >99% ee, [α]_{D}²⁰=−0.676° (c=7.65 g/100 mL, CHCl₃), absolute configuration=R] was added, and then a 1.0M toluene solution of triisobutylaluminum (0.25 mL, 0.25 mmol) was added, followed by stirring at 0° C. for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using methylene chloride. The resulting mixed solution was concentrated and dried under vacuum and methylene chloride (90 mL) was added to the residue to dissolve a polymer. After insoluble matter was filtrated off, the filtrate was concentrated and dried under vacuum to obtain a polymer. On this occasion, in order to remove the residue of the initiator and oligomers, a re-precipitation treatment was performed using methylene chloride and hexane to thereby isolate the polymer [610 mg, yield 97%, Mₙ=21,000 (g/mol), M_{w}/Mₙ=1.6, [α]_{D}²²=+5.69° (c=1.54 g/100 mL, CHCl₃)].

When ¹³C-NMR (125 MHz, solvent: C₆F₆) of the polymer was measured, the peak derived from methylene in the main chain of the polymer was observed only at 72.18 ppm (mm triplet).

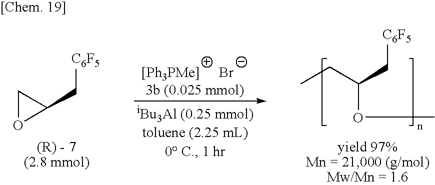

### Example 12

Under an argon gas atmosphere, methyltriphenylphosphonium bromide (3b) (8.9 mg, 0.025 mmol) and toluene (2.0 mL) were placed in a 20 mL volume Schlenk tube reactor, an epoxide (8) (Q=—CH₂O—, R^{F}═—C₆F₅ in the formula (1), 0.44 mL, 2.80 mmol) was added, and then a 11.0M toluene solution of triisobutylaluminum (0.25 mL, 0.25 mmol) was added, followed by stirring at 0° C. for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using methylene chloride. The resulting mixed solution was concentrated and dried under vacuum and methylene chloride (90 mL) was added to the residue to dissolve a polymer. After insoluble matter was filtrated off, the filtrate was concentrated and dried under vacuum to obtain a polymer. On this occasion, in order to remove the residue of the initiator and oligomers, a re-precipitation treatment was performed using methylene chloride and hexane to thereby isolate the polymer [591 mg, yield 88%, Mₙ=24,000 (g/mol), M_{w}/Mₙ=2.4].

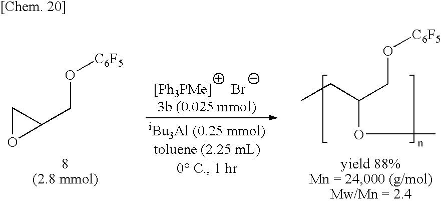

### Example 13

Under an argon gas atmosphere, methyltriphenylphosphonium bromide (3b) (8.9 mg, 0.025 mmol) and toluene (2.0 mL) were placed in a 20 mL volume Schlenk tube reactor, an optically almost pure epoxide (8) [0.44 mL, 2.80 mmol, >99% ee, [α]_{D}²⁰=+1.08° (c=7.65 g/100 mL, CHCl₃), absolute configuration=S] was added, and then a 1.0M toluene solution of triisobutylaluminum (0.25 mL, 0.25 mmol) was added, followed by stirring at 0° C. for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using methylene chloride. The resulting mixed solution was concentrated and dried under vacuum and heated toluene (50 mL) was added to the residue to dissolve a polymer, followed by further washing with 150 mL of methylene chloride. After insoluble matter was filtrated off, the filtrate was concentrated and dried under vacuum to obtain a polymer. On this occasion, in order to remove the residue of the initiator and oligomers, a re-precipitation treatment was performed using methylene chloride and hexane to thereby isolate the polymer [639 mg, yield 95%, Mₙ=26,000 (g/mol), M_{w}/Mₙ=1.6, [α]_{D}²²=+3.01° (c=0.308 g/100 mL, THF)].

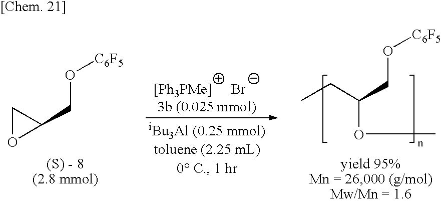

### Example 14

Under an argon gas atmosphere, methyltriphenylphosphonium bromide (3b) (8.9 mg, 0.025 mmol) and toluene (2.0 mL) were placed in a 20 mL volume Schlenk tube reactor, an epoxide (9) (Q=a single bond, R^{F}═—C₆F₅ in the formula (1), 0.37 mL, 2.80 mmol) was added, and then a 1.0M toluene solution of triisobutylaluminum (0.25 mL, 0.25 mmol) was added, followed by stirring at 0° C. for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using methylene chloride. The resulting mixed solution was concentrated and dried under vacuum and methylene chloride (90 mL) was added to the residue to dissolve a polymer. After insoluble matter was filtrated off, the filtrate was concentrated and dried under vacuum to obtain a polymer. On this occasion, in order to remove the residue of the initiator and oligomers, a re-precipitation treatment was performed using methylene chloride and hexane to thereby isolate the polymer [304 mg, yield 52%, Mₙ=6,000 (g/mol), M_{w}/Mₙ=1.3].

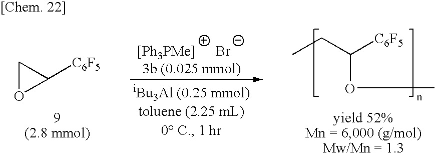

### Example 15

Under an argon gas atmosphere, methyltriphenylphosphonium bromide (3b) (8.9 mg, 0.025 mmol) and toluene (2.0 mL) were placed in a 20 mL volume Schlenk tube reactor, an epoxide (10) (Q=—CH₂O—, R^{F}=—CF₃ in the formula (1), 0.28 mL, 2.80 mmol) was added, and then a 1.0M toluene solution of triisobutylaluminum (0.25 mL, 0.25 mmol) was added, followed by stirring at 0° C. for 1 hour.

A mixed solution of methanol/water/conc. hydrochloric acid (5 mL, methanol/water/conc. hydrochloric acid=8/2/1) was added to the reaction vessel to terminate the reaction and the crude product was transferred into a round-bottom flask using AK225. The resulting mixed solution was concentrated and dried under vacuum and AK225 (30 mL) was added to the residue to dissolve a polymer. After insoluble matter was filtrated off, the filtrate was concentrated and dried under vacuum to obtain a polymer. On this occasion, in order to remove the residue of the initiator and oligomers, a re-precipitation treatment was performed using methylene chloride and hexane to thereby isolate the polymer [352 mg, yield 99%, Mₙ=16,000 (g/mol), M_{w}/Mₙ=1.7].

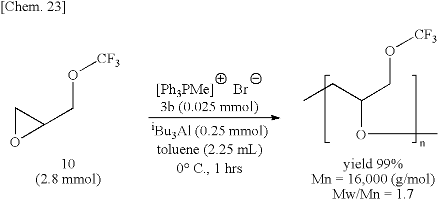

### INDUSTRIAL APPLICABILITY

According to the process of the invention, a fluoropolymer having high heat resistance and light resistance attributed to the stability of a C—F bond is provided. The fluoropolymer of the invention also has electrical/optical functions attributed to a fluorine atom in combination, so that it is a specific functional optical material that cannot be realized by the other polymer material. For example, an isotactic fluorinated polyether is useful as oil, rubber, and the like.

While the invention has been described in detail and with reference to specific embodiments thereof, it will be apparent to one skilled in the art that various changes and modifications can be made therein without departing from the spirit and scope thereof.

The present application is based on Japanese Patent Application No. 2006-066444 filed on Mar. 10, 2006, and the contents are incorporated herein by reference.

1. A process for producing a fluoropolymer having two or more units of a repeating unit represented by the following formula (2), which comprises ring-opening polymerization of a fluorinated epoxy compound represented by the following formula (1) in the presence of a trialkylaluminum and a salt having an organic cation as a counter cation: 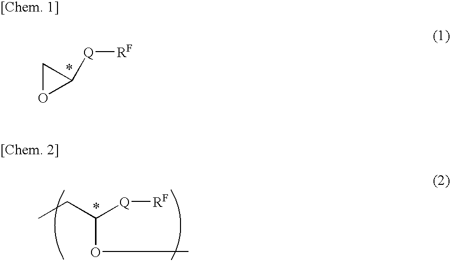
wherein Q represents a single bond or a bivalent linking group containing no fluorine atom; R^{F} represents a monovalent organic group containing a fluorine atom; and * indicates that the carbon atom marked with * is an asymmetric carbon atom.

2. The process for producing the fluoropolymer according to claim 1, wherein the ring-opening polymerization is a reaction of ring-opening homopolymerization of a fluorinated epoxy compound represented by the formula (1).

3. The process for producing the fluoropolymer according to claim 1 or 2, wherein the fluorinated epoxy compound represented by the formula (1) consists of a compound in which the absolute configuration of the asymmetric carbon atom marked with * is either exclusively S or exclusively R and the absolute configuration of the asymmetric carbon atom marked with * in the repeating unit represented by the following formula (2) is substantially the same as the absolute configuration of the asymmetric carbon atom in the fluorinated epoxy compound represented by the formula (1).

4. The process for producing the fluoropolymer according to claim 1, wherein the trialkylaluminum is triisobutylaluminum and the salt having an organic cation as a counter cation is a cation represented by the following formula (3-1) or the following formula (3-2):
[Chem. 3]
[Ph₃P═N═PPh₃]⁺ (3-1)
[Chem. 4]
[Ph₃PMe]⁺ (3-2)
wherein Ph represents a phenyl group and Me represents a methyl group.

5. The process for producing the fluoropolymer according to claim 2, wherein the trialkylaluminum is triisobutylaluminum and the salt having an organic cation as a counter cation is a cation represented by the following formula (3-1) or the following formula (3-2):
[Chem. 3]
[Ph₃P═N═PPh₃]⁺ (3-1)
[Chem. 4]
[Ph₃PMe]⁺ (3-2)
wherein Ph represents a phenyl group and Me represents a methyl group.

6. The process for producing the fluoropolymer according to claim 3, wherein the trialkylaluminum is triisobutylaluminum and the salt having an organic cation as a counter cation is a cation represented by the following formula (3-1) or the following formula (3-2):
[Chem. 3]
[Ph₃P═N═PPh₃]⁺ (3-1)
[Chem. 4]
[Ph₃PMe]⁺ (3-2)
wherein Ph represents a phenyl group and Me represents a methyl group.
